(19) United States
(12) Patent Application Publication
(10) Pub. No.: US 2019/0385517 A1
(43) Pub. Date: Dec. 19, 2019

(54) FOLDABLE DISPLAY PANEL AND DRIVING METHOD THEREOF

(71) Applicant: Wuhan China Star Optoelectronics Semiconductor Display Technology Co., Ltd., Wuhan, Hubei (CN)

(72) Inventor: Mian ZENG, Wuhan, Hubei (CN)

(21) Appl. No.: 15/737,560

(22) PCT Filed: Nov. 28, 2017
(86) PCT No.: PCT/CN2017/113419

§ 371 Date: Dec. 18, 2017

(30) Foreign Application Priority Data
Nov. 22, 2017 (CN) 201711177016.X

(51) Int. Cl. G09G 3/3225; G09F 9/30

(52) U.S. Cl. CPC G09G 3/3225; G09G 2310/0286; G09G 2300/0426; G09F 9/301

(57) ABSTRACT

A foldable display panel is provided. The foldable display panel comprising flexible substrate includes first display region and second display region, between first display region and second display region is foldable; N first grid electrode driving circuits positioned on flexible substrate and by sequentially arranged on lateral side of first display region, N is integer number. M second grid electrode driving circuits positioned on flexible substrate and by sequentially arranged on a lateral side of second display region, M is integer number, N first grid electrode driving circuits connected in cascade with M second grid electrode driving circuits; M reset modules correspondingly positioned in second grid electrode driving circuit, reset module pull-down outputting signal of correspondingly second grid electrode driving circuit to low potential by enabling signal which outside inputted when folding first display region and second display region such that turn-off all M second grid electrode driving circuits.

### RELATED APPLICATIONS

The present application is a National Phase of International Application Number PCT/CN2017/113419, filed Nov. 28, 2017, and claims the priority of China Application No. 201711177016.X, filed Nov. 22, 2017.

### FIELD OF THE DISCLOSURE

The disclosure relates to a display technical field, and more particularly to a foldable display panel and a driving method of foldable display.

### BACKGROUND

With the increasingly requirements of portable display device, the flexible display technology become a very competitive technology. The huge advantageous of flexible display technology is foldable, such that could increasing display area without increases the volume of display device, easily be portable. FIG. 1 is prior art of a structural schematic view of a foldable display panel, the flexible and foldable display panel could fold along the dashed line XL (it is not be really existence).

Gate on Array technology which is integrated the grid electrode switch of Thin Film Transistor on the array substrate. Therefore, saving the space which originally positioning the grid electrode driving integrated circuit on the outside of array substrate, and decreasing products cost by material and manufacture process. GOA technology is the most common grid electrode driving circuit technology of display technology, and it has simplified manufacture, and has preferable application prospects. The main function of GOA circuit includes providing high signal outputted by the previous GOA circuit to the next GOA circuit for turn-on the next GOA circuit, such that transmission the clock signal to scan line which connected to the next GOA circuit. Please refer to FIG. 2, CK and XCK are both indicate clock signals, Vgh indicates high potential voltage, Vgl indicates low potential voltage.

The currently folding way including folding up to down (shown as FIG. 3) or folding three times. After folding, the upwardly display surface will become a main display surface, the downwardly display panel will not display for saving consumption. However, the initial signal of GOA circuit generally form the first row and pass the shift register circuit of GOA circuit, then downwardly generating outputting signal shift by row. Or, inputting initial signal form the final row and pass the shift register circuit of GOA circuit, then upwardly generating outputting signal shift by row. And forward scan or reverse scan according to the forward scan signals and reverse scan signals with outputting signals. This king design has a big disadvantage: when the flexible display device been folding, GOA signal still will transmits from the first row to following rows or from the last row to previously rows. So that, if make the upwardly display panel displaying image and the downwardly display panel will not displaying image after folding, the Integrated Circuit terminal needs to input a plurality of 0 gray-step data signals. On the other side, only needs the GOA circuit which corresponding to the upwardly display surface be worked, and the GOA circuit which corresponding to the upwardly display surface don't need to be worked, but after folding the GOA circuit which corresponding to the upwardly display surface still be worked causes wasting of power consumption.

### SUMMARY

A technical problem to be solved by the disclosure is to provide a foldable display panel and a driving method of foldable display panel, which turn-off the correspondingly GOA circuit of the non-display surface after folding.

An objective of the disclosure is achieved by following embodiments. In particular, a foldable display panel includes a flexible substrate, and N first grid electrode driving circuits, M second grid electrode driving circuits and M reset modules. The flexible substrate includes a first display region and a second display region, between the first display region and the second display region is foldable. The N first grid electrode driving circuits positioned on the flexible substrate and by sequentially arranged on a lateral side of the first display region, N is integer number. The M second grid electrode driving circuits positioned on the flexible substrate and by sequentially arranged on a lateral side of the second display region, M is integer number, the N first grid electrode driving circuits connected in cascade with M second grid electrode driving circuits. The M reset modules, the M reset modules correspondingly positioned in the second grid electrode driving circuit, the reset module pull-down an outputting signal of the correspondingly second grid electrode driving circuit to low potential by an enabling signal which outside inputted when folding the first display region and the second display region such that turn-off all of the M second grid electrode driving circuits.

In an embodiment, the M reset modules all connected to an enabling signal generator and the enabling signal generator is triggered to generate the enabling signal when folding the first display region and the second display region.

In an embodiment, each of reset modules is connected to a correspondingly enabling signal generator and each of enabling signal generators is triggered to generate the enabling signal when folding the first display region and the second display region.

In an embodiment, in the N first grid electrode driving circuits, a (i+1)th first grid electrode driving circuit is connected to an outputting terminal of a i th first grid electrode driving circuit for receiving an outputting signal outputted by the i th first grid electrode driving circuit, wherein 1≤i≤N−1 and N≥2.

In an embodiment, in the M second grid electrode driving circuits, a (j+1)th second grid electrode driving circuit is connected to an outputting terminal of a j th second grid electrode driving circuit for receiving an outputting signal outputted by the j th second grid electrode driving circuit, wherein 1≤j≤M−1 and M≥2.

In an embodiment, a 1 th second grid electrode driving circuit is connected to an outputting terminal of a N th first grid electrode driving circuit for receiving an outputting signal outputted by the N th first grid electrode driving circuit.

In an embodiment, the reset module comprises a transistor, a grid electrode of the transistor for receiving the enabling signal, a first electrode of the transistor is connected to an outputting terminal of the correspondingly second grid electrode driving circuit, a second electrode of the transistor is connected to a low potential line.

In an embodiment, the transistor is an n-channel transistor.

In an embodiment, the foldable display panel is a foldable liquid crystal display panel or foldable OLED panel.

According to another aspect of the disclosure, the disclosure further provides a driving method of the foldable display panel. The driving method of the foldable display panel comprises: Receiving an enabling signal which outside inputted when folding the first display region and the second display region; Pulling-down an outputting signal of the correspondingly second grid electrode driving circuit to low potential of the reset module, such that turn-off all of the second grid electrode driving circuits.

The advantageous of this present invention, turn-off the correspondingly grid electrode driving circuits of the non-displaying zone in the display region, such that will not be power consumption. In addition, there is no need to input a plurality of 0 gray step data signals from outside integrate circuit according to turn-off the correspondingly grid electrode driving circuits of the non-displaying zone in the display region.

### BRIEF DESCRIPTION OF THE DRAWINGS

Accompanying drawings are for providing further understanding of embodiments of the disclosure. The drawings form a part of the disclosure and are for illustrating the principle of the embodiments of the disclosure along with the literal description. Apparently, the drawings in the description below are merely some embodiments of the disclosure, a person skilled in the art can obtain other drawings according to these drawings without creative efforts. In the figures:

FIG. 1 is prior art of a structural schematic view of a foldable display panel;

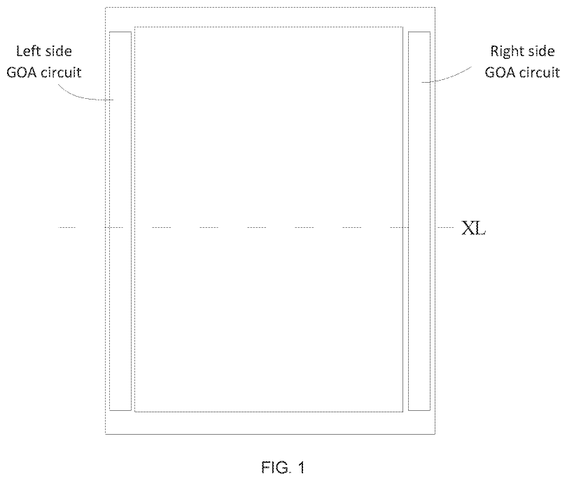

FIG. 2 is prior art of a structural schematic view of a plurality of GOA circuit connected in cascade;

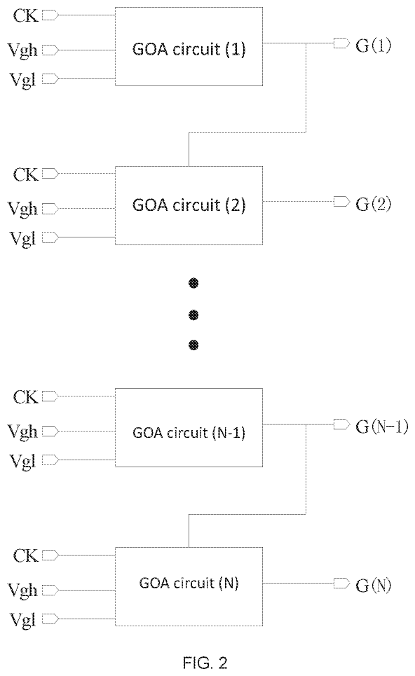

FIG. 3 is a state chart view of a foldable display panel after folding according to an embodiment of the disclosure;

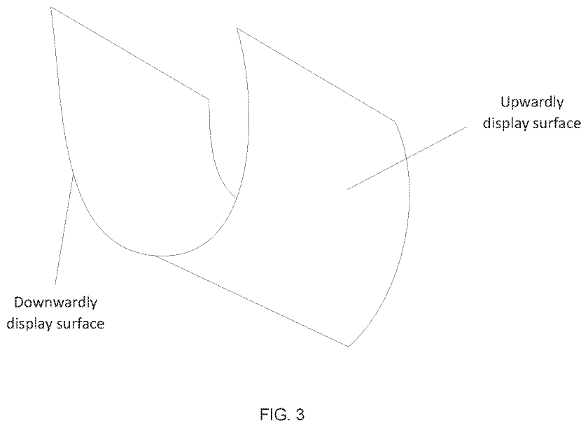

FIG. 4 is a schematic view of a foldable display panel according to an embodiment of the disclosure; and

FIG. 5 is a circuit diagram of a reset module according to an embodiment of the disclosure.

### DETAILED DESCRIPTION OF PREFERRED EMBODIMENTS

The specific structural and functional details disclosed herein are only representative and are intended for describing exemplary embodiments of the disclosure. However, the disclosure can be embodied in many forms of substitution, and should not be interpreted as merely limited to the embodiments described herein.

In the drawings, the thickness of layers and regions are exaggerated for clarity. Like numbers refer to like elements throughout. As used herein the term “and/or” includes any and all combinations of one or more of the associated listed items.

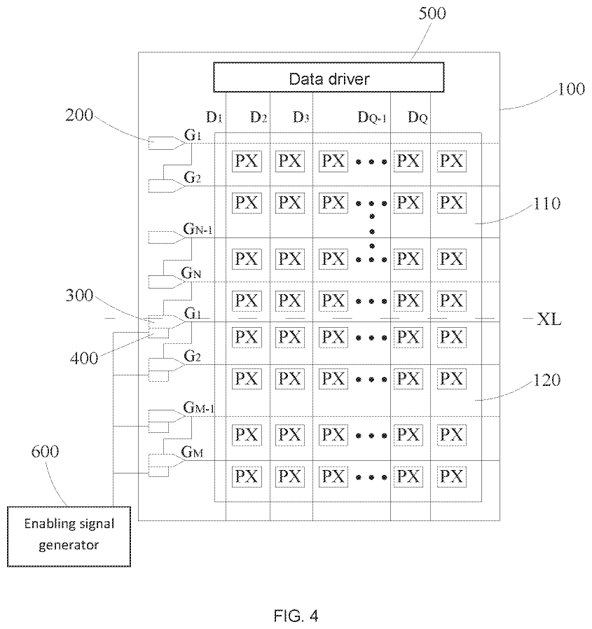

FIG. 4 is a schematic view of a foldable display panel according to an embodiment of the disclosure.

Please refer to FIG. 4. The foldable display panel of the embodiment in this disclosure which is a foldable liquid crystal display panel or foldable OLED panel. The foldable display panel comprises a flexible substrate 100, N first grid electrode driving circuits 200, M second grid electrode driving circuits 300, M reset modules 400, data driver 500 and an enabling signal generator 600. Wherein, N and M both are integer numbers.

The flexible substrate 100 includes a first display region 110 and a second display region 120. In other embodiment, the flexible substrate 100 could comprise more display regions for example could be divides to three or more display regions. In this embodiment, the first display region 110 is positioned above the second display region 120, but here is not limited thereto, which also could be another kind positioned for example the first display region 110 and the second display region 120 is divided by left side and right side. Further, between the first display region 110 and the second display region 120 is foldable, which is the first display region 110 and the second display region 120 is folding along the dashed line XL of FIG. 4 (it is not be really existence).

The first display region 110 and the second display region 120 are respectively comprises many pixel PX arranged in array. D₁ to D_{Q} of Q data lines are positioned in the first display region 110 and the second display region 120, and D₁ to D_{Q} of Q data lines are both connected to the data driver 500 for receiving data voltage. The first display region 110 comprises G₁ to G_{N} of N scan lines, the second display region 120 comprises G₁ to G_{M} of M scan lines.

N first grid electrode driving circuits 200 are positioned on the flexible substrate 100 and by sequentially arranged from top to down on a lateral side of the first display region 110. In other embodiment, the N first grid electrode driving circuits 200 are respectively positioned on correspondingly two lateral sides of the first display region 110. Each G₁ to G_{N} of N scan lines is connected to correspondingly the first grid electrode driving circuits 200 for receiving scan signals. Wherein, in each of the first grid electrode driving circuits 200, CK and XCK are both indicate clock signals in each of the first grid electrode driving circuits 200, Vgh indicates high potential voltage, Vgl indicates low potential voltage.

M second grid electrode driving circuits 300 are positioned on the flexible substrate 100 and by sequentially arranged from top to down on a lateral side of the second display region 120. In other embodiment, the M second grid electrode driving circuits 300 are respectively positioned on correspondingly two lateral sides of the second display region 120. Each G1 to GM of M scan lines is connected to correspondingly the second grid electrode driving circuits 300 for receiving scan signals. Wherein, in each of the second grid electrode driving circuits 300, CK and XCK are both indicate clock signals in each of the first grid electrode driving circuits 200, Vgh indicates high potential voltage, Vgl indicates low potential voltage.

N first grid electrode driving circuits 200 and M second grid electrode driving circuits 300 are connected in cascaded. Generally, the grid electrode driving circuits manufactured on the flexible substrate 100 is GOA (Gate on Array) circuit.

Which is, in the N first grid electrode driving circuits 200, a (i+1)th first grid electrode driving circuit 200 is connected to an outputting terminal of a ith first grid electrode driving circuit 200 for receiving an outputting signal outputted by the ith first grid electrode driving circuit 200. The outputting signal usually has high potential, and 1≤i≤N−1 and N≥2. So that, turn-on the next of the first grid electrode driving circuit 200 by high potential signal outputted by the previous of the first grid electrode driving circuit 200 for finishing stage-transmission,

In the M second grid electrode driving circuits 300, a (j+1)th second grid electrode driving circuit 300 is connected to an outputting terminal of a jth second grid electrode driving circuit 300 for receiving an outputting signal outputted by the jth second grid electrode driving circuit 300. The outputting signal usually has high potential, and 1≤j≤M−1 and M≥2. So that, turn-on the next of the second grid electrode driving circuit 300 by high potential signal outputted by the previous of the second grid electrode driving circuit 300 for finishing stage-transmission.

Further, a 1th second grid electrode driving circuit 300 is connected to an outputting terminal of a Nth first grid electrode driving circuit 200 for receiving an outputting signal outputted by the Nth first grid electrode driving circuit 200, and the outputting signal is high potential. So that, turn-on the 1th second grid electrode driving circuit 300 by high potential signal outputted by the Nth second grid electrode driving circuit 300 for finishing stage-transmission,

Each of the M reset modules 400 is correspondingly positioned in the second grid electrode driving circuit 300. The reset module 400 pull-down an outputting signal of the correspondingly second grid electrode driving circuit 300 from high potential to low potential by an enabling signal which outside inputted when folding the first display region 110 and the second display region 120 along the dashed line XL, such that turn-off all of the M second grid electrode driving circuits 300.

In another embodiment, Nth first grid electrode driving circuit 200 could positioning a reset module 400, and respectively positioning reset modules 400 in the 1th second grid electrode driving circuit 300 to (M−1)th second grid electrode driving circuit 300. So that, when folding the first display region 110 and the second display region 120 along the dashed line XL, the outputting signal of the Nth first grid electrode driving circuit 200 is pull-sown to low potential, and the outputting signals of the 1 th second grid electrode driving circuit 300 to (M−1)th second grid electrode driving circuit 300 are also pull-sown to low potentials, such that turn-off all of the second grid electrode driving circuits 300.

In this embodiment, the enabling signals are generated by the enabling signal generator 600. In FIG. 4, for convince illustrating, the enabling signal generator 600 is not shown on the flexible substrate 100, and the enabling signal generator 600 is integrated on the flexible substrate 100 of the reality. Specifically, when folding the first display region 110 and the second display region 120 along the dashed line XL, the enabling signal generator 600 is triggered to generate the enabling signal. The reset module 400 is respectively pull-down the outputting signal from high potential to low potential of the second grid electrode driving circuits 300 according the enabling signal, such that turn-off the Mth second grid electrode driving circuits 300.

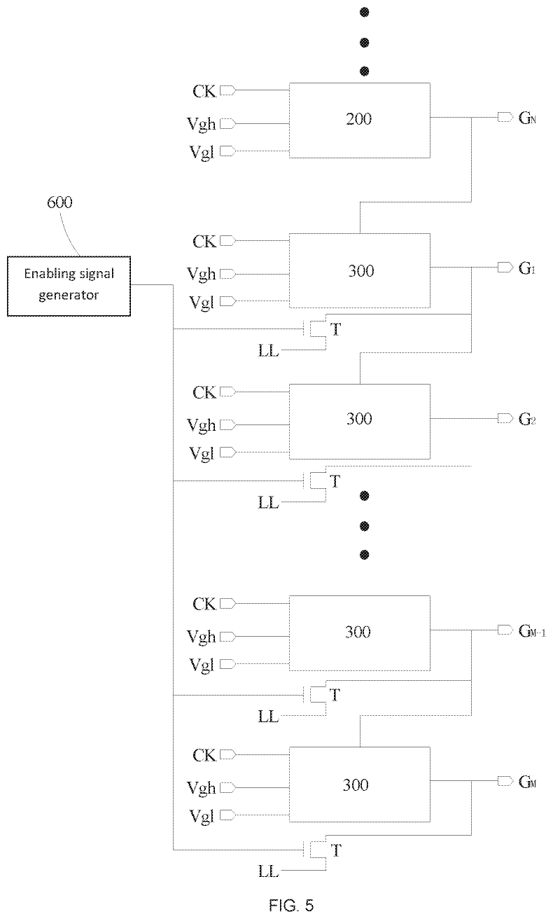

FIG. 5 is a circuit diagram of a reset module according to an embodiment of the disclosure,

Please refer to the FIG. 5. The reset module 400 of the embodiment in this present invention includes transistor T, but here is not limit thereto. A grid electrode of the transistor T is connected to the enabling signal generator 600 for receiving the enabling signal. A first electrode of the transistor T is connected to an outputting terminal of the correspondingly second grid electrode driving circuit 300, a second electrode of the transistor T is connected to a low potential line LL. Wherein, the low potential line LL for providing a low potential signal,

When folding the first display region 110 and the second display region 120 along the dashed line XL, the enabling signal generator 600 is trigger to generate a high potential enabling signal. The high potential enabling signal is turn-on the transistor T, and the first electrode is pull-down to low-potential, which is pull-down the outputting signal of the outputting terminal of the second grid electrode driving circuit 300 to low potential.

In this embodiment, the transistor T is an n-channel transistor, but here is not limited thereto. In addition, the first electrode could be one of the source or drain of the transistor T, and the second electrode could be another of the source or drain of the transistor T, but here is not limited thereto.

In this embodiment further provides a driving method of the foldable display panel shown as FIG. 4, comprising:

Step 1, when folding the first display region 110 and the second display region 120 along the dashed line XL, the enabling signal generator is triggered and generating an enabling signal has high potential;

Step 2, pulling-down an outputting signal of the correspondingly second grid electrode driving circuit 300 from high potential to low potential of the reset module 400, such that turn-off the M second grid electrode driving circuits 300.

In sum, according to the embodiment of this present invention. Turn-off the correspondingly second grid electrode driving circuits of the non-displaying zone in the second display region, such that will not be power consumption. In addition, there is no need to input a plurality of 0 gray step data signals from outside integrate circuit according to turn-off the correspondingly the second grid electrode driving circuits of the non-displaying zone in the second display region.

The foregoing contents are detailed description of the disclosure in conjunction with specific preferred embodiments and concrete embodiments of the disclosure are not limited to these description. For the person skilled in the art of the disclosure, without departing from the concept of the disclosure, simple deductions or substitutions can be made and should be included in the protection scope of the application.

What is claimed is:

1. A foldable display panel comprising
a flexible substrate includes a first display region and a second display region, between the first display region and the second display region is foldable;
N first grid electrode driving circuits positioned on the flexible substrate and by sequentially arranged on a lateral side of the first display region, N is integer number;
M second grid electrode driving circuits positioned on the flexible substrate and by sequentially arranged on a lateral side of the second display region, M is integer number, the N first grid electrode driving circuits connected in cascade with M second grid electrode driving circuits;
M reset modules, the M reset modules correspondingly positioned in the second grid electrode driving circuit, the reset module pull-down an outputting signal of the correspondingly second grid electrode driving circuit to low potential by an enabling signal which outside inputted when folding the first display region and the second display region such that turn-off all of the M second grid electrode driving circuits.

2. The foldable display panel according to claim 1, wherein the M reset modules all connected to an enabling signal generator and the enabling signal generator is triggered to generates the enabling signal when folding the first display region and the second display region.

3. The foldable display panel according to claim 1, wherein each of reset modules is connected to a correspondingly enabling signal generator and each of enabling signal generators is triggered to generates the enabling signal when folding the first display region and the second display region.

4. The foldable display panel according to claim 1, wherein in the N first grid electrode driving circuits, a (i+1)th first grid electrode driving circuit is connected to an outputting terminal of a ith first grid electrode driving circuit for receiving an outputting signal outputted by the ith first grid electrode driving circuit, wherein 1≤i≤N−1 and N≥2.

5. The foldable display panel according to claim 2, wherein in the N first grid electrode driving circuits, a (i+1)th first grid electrode driving circuit is connected to an outputting terminal of a ith first grid electrode driving circuit for receiving an outputting signal outputted by the ith first grid electrode driving circuit, wherein 1≤i≤N−1 and N≥2.

6. The foldable display panel according to claim 3, wherein in the N first grid electrode driving circuits, a (i+1)th first grid electrode driving circuit is connected to an outputting terminal of a ith first grid electrode driving circuit for receiving an outputting signal outputted by the ith first grid electrode driving circuit, wherein 1≤i≤N−1 and N≥2.

7. The foldable display panel according to claim 4, wherein in the M second grid electrode driving circuits, a (j+1)th second grid electrode driving circuit is connected to an outputting terminal of a jth second grid electrode driving circuit for receiving an outputting signal outputted by the ⱼth second grid electrode driving circuit, wherein 1≤j≤M−1 and M≥2.

8. The foldable display panel according to claim 5, wherein in the M second grid electrode driving circuits, a (j+1)th second grid electrode driving circuit is connected to an outputting terminal of a jth second grid electrode driving circuit for receiving an outputting signal outputted by the jth second grid electrode driving circuit, wherein 1≤j≤M−1 and M≥2.

9. The foldable display panel according to claim 6, wherein in the M second grid electrode driving circuits, a (j+1)th second grid electrode driving circuit is connected to an outputting terminal of a jth second grid electrode driving circuit for receiving an outputting signal outputted by the ⱼth second grid electrode driving circuit, wherein 1≤j≤M−1 and M≥2.

10. The foldable display panel according to claim 7, wherein a 1th second grid electrode driving circuit is connected to an outputting terminal of a Nth first grid electrode driving circuit for receiving an outputting signal outputted by the Nth first grid electrode driving circuit,

11. The foldable display panel according to claim 8, wherein a 1th second grid electrode driving circuit is connected to an outputting terminal of a Nth first grid electrode driving circuit for receiving an outputting signal outputted by the Nth first grid electrode driving circuit.

12. The foldable display panel according to claim 9, wherein a 1 th second grid electrode driving circuit is connected to an outputting terminal of a Nth first grid electrode driving circuit for receiving an outputting signal outputted by the Nth first grid electrode driving circuit.

13. The foldable display panel according to claim 1, wherein the reset module comprises a transistor, a grid electrode of the transistor for receiving the enabling signal, a first electrode of the transistor is connected to an outputting terminal of the correspondingly second grid electrode driving circuit, a second electrode of the transistor is connected to a low potential line.

14. The foldable display panel according to claim 13, wherein the transistor is an n-channel transistor.

15. The foldable display panel according to claim 1, wherein the foldable display panel is a foldable liquid crystal display panel or foldable OLED panel.

16. A driving method of the foldable display panel according to claim 1, comprising:
receiving an enabling signal which outside inputted when folding the first display region and the second display region;
pulling-down an outputting signal of the correspondingly second grid electrode driving circuit to low potential of the reset module, such that turn-off all of the second grid electrode driving circuits.
